(19) United States
(12) Patent Application Publication
(10) Pub. No.: US 2008/0028016 A1
(43) Pub. Date: Jan. 31, 2008

(54) PRIORITIZATION OF COMMUNICATION SERVICES ACROSS MULTIPLE SERVICE INITIATORS IN A MULTI-MODAL COMMUNICATION DEVICE

(75) Inventors: Ketan N. Desai, Sunrise, FL (US); Jose E. Korneluk, Lake Worth, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/461,275

(22) Filed: Jul. 31, 2006

(51) Int. Cl. G06F 15/16

(52) U.S. Cl. 709/200

(57) ABSTRACT

A method (600) for prioritizing communication services across multiple service initiators in a multi-modal communication device (110). The method can include establishing an inter-process communications link (140) between a first processor (125) and at least a second processor (130) within the communication device. Responsive to a request (202) for a first service provided by the first processor, a determination can be made whether the first service has a higher priority than a second service currently active on a second processor. A conflict message can be provided in response to the second service having a higher priority than the first service, or at least one process, such as initiation of the first service, can be implemented in response to the first service having a higher priority than the second service. Further service initiated messages (204, 206) can be communicated from the second process to an external device and to the first processor.

### BACKGROUND OF THE INVENTION

1. Field of the Invention

The present invention generally relates to communication devices and, more particularly, to multi-modal communication devices.

2. Background of the Invention

The use of mobile stations has grown to an extent that such devices are now ubiquitous throughout most of the industrialized world. Just as their use has grown, so too has the functionality of the mobile stations. Indeed, mobile stations now can be used not only for voice communications, but also to perform a number of other tasks. For example, mobile stations can be used to browse the Internet, send and receive e-mail and instant messages, play games, take photographs and capture video.

Many mobile stations also can function as wireless modems to support circuit data calls for external devices, such as personal computers. Such a mobile station can include, for example, a communications port to which a computer's network adapter can be connected. Thus, rather than being limited to the use of a typical wired or wireless local area network, the computer can be provided increased mobility by using the mobile station as a modem to connect to other communications networks, such as cellular communications networks. While the mobile station is operating as a modem, however, other services on the mobile station may not properly function. Accordingly, the mobile station may not be able to respond appropriately to various service requests.

### SUMMARY OF THE INVENTION

The present invention relates to a method for prioritizing communication services across multiple service initiators in a multi-modal communication device. The method can include establishing an inter-process communications link between a first processor and at least a second processor within the communication device. Responsive to a request for a first service provided by the first processor, a determination can be made whether the first service has a higher priority than a second service currently active on a second processor. A conflict message can be provided in response to the second service having a higher priority than the first service, or at least one process can be initiated in response to the first service having a higher priority than the second service. Initiating at least one process can include initiating the first service.

Responsive to the first service being initiated, a service initiated message can be communicated from the second processor to an external device. In addition, responsive to the first service being initiated, a service initiated message can be communicated from the second processor to the first processor. The method also can include terminating the first service. Responsive to the first service being terminated, a service terminated message can be communicated from the second processor to an external device. In addition, responsive to the first service being terminated, a service terminated message can be communicated from the second processor to the first processor. The method also can include determining whether the first service has a higher priority than a third service currently active on a first processor. A conflict message can be provided in response to the third service having a higher priority than the first service.

The present invention also relates to a multi-modal communication device that includes a first processor and a second processor communicatively linked to the first processor via an inter-process communications link. Responsive to a request for a first service provided by the first processor, the communication device can determine whether the first service has a higher priority than a second service currently active on a second processor. The communication device also can present a conflict message in response to the second service having a higher priority than the first service, or initiate at least one process in response to the first service having a higher priority than the second service. The process that is initiated can be initiation of the first service.

The communication device can communicate a service initiated message from the second processor to an external device in response to the first service being initiated. The communication device also can communicate a service initiated message from the second processor to the first processor in response to the first service being initiated. The communication device further can terminate the first service and, responsive to the first service being terminated, communicate a service terminated message from the second processor to an external device. Responsive to the first service being terminated, the communication device also can communicate a service terminated message from the second processor to the first processor. The communication device can determine whether the first service has a higher priority than a third service currently active on a first processor. Responsive to the third service having a higher priority than the first service, the communication device can provide a conflict message.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a signal flow diagram that is useful for understanding the present invention;

FIG. 3 depicts another signal flow diagram that is useful for understanding the present invention;

FIG. 4 depicts another signal flow diagram that is useful for understanding the present invention;

FIG. 5 depicts yet another signal flow diagram that is useful for understanding the present invention;

FIG. 6 is a flowchart that is useful for understanding the present invention; and

FIG. 7 is a priority table that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system for prioritizing communication services across multiple service initiators in a multi-modal communication device. For example, inter-process communications can be established between two or more processors within the communication device. When a request for a service provided by a particular processor is received, the priority levels of services that are currently active on other processors can be considered when determining the appropriate response to the request. For example, if a service having higher priority than the requested service is currently active, and initiation of the requested service would interrupt the higher priority service, an error message can be provided in response to the request. Accordingly, the higher priority service can be maintained without interruption until the higher priority service is no longer required.

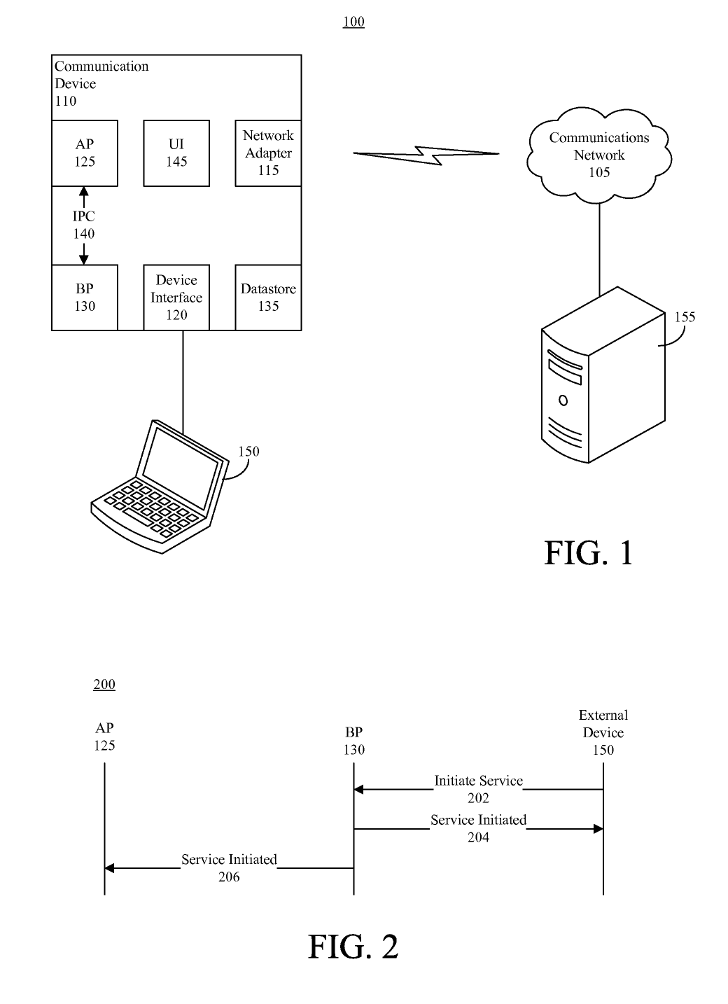

FIG. 1 depicts a communications system 100 that is useful for understanding the present invention. The communications system 100 can include a communications network 105, which can comprise, for example, the Internet, the World Wide Web, a wide area network (WAN), a local area network (LAN), a cellular communications network, a dispatch communications network, an interconnect communications network, a public switched telephone network (PSTN), and/or any other networks or systems over which communication signals can be propagated. In that regard, the communications network can include wired and/or wireless communication links.

The communications system 100 can include a communication device 110. The communication device 110 can be a mobile station, such as a mobile computer, a personal digital assistant (PDA) or a mobile telephone, a game console, or any other electronic apparatus that may be used to wirelessly communicate with the communications network 105. The communication device 110 can include a network adapter 115 to support communications between the communication device 100 and the communications network 105. The network adapter 115 can be, for example, a transceiver that supports wireless communications and/or an adapter that supports wired communications.

The communication device 110 also can include an external device interface 120 to support communications with an external device 150. For example, the external device interface 120 can be a communications port, such as a network adapter, a universal serial bus (USB) interface, an enhanced mini USB (EMU) interface, an IEEE-1394 (FireWire) interface, or any other interface suitable for supporting communications with an external device 150. The external device 150 can be, for instance, a computer, a personal digital assistant, a gaming device, or any other device which can be communicatively linked to a communications device.

The communication device 110 further can include one or more processors, such as an application processor 125 and/or a baseband processor 130. The application processor 125 can execute applications, including services that run at the application layer. The baseband processor 130 also can execute applications, as well as execute baseband communications services. The applications/services can be stored in one or more datastores 135. A datastore 135 can comprise an electronic storage medium, a magnetic storage medium, an optical storage medium, a magneto-optical storage medium, or any other storage medium suitable for storing software or firmware.

An inter-process communications link 140 can be established between the application processor 125 and the baseband processor 130. The inter-process communication link can be implemented as a process which passes data from the application processor 125 to the baseband processor 130, and from the baseband processor 130 to the application processor 125. Such passing of data can be accomplished using methods known in the art. One example of such a method can use dual port random access memory that is accessible by both processors 125, 130, but other techniques can be used and the invention is not limited in this regard.

In operation, a call, for instance a circuit data call, can be initiated to establish a data communication link between the external device 150 and another device communicatively 155 linked to the communications network 105 via the communication device 110. The call can be initiated by a service instantiated on the application processor 125 or a service instantiated on the baseband processor 130. For example, the call may be requested via a user interface 145 on the communication device 110, in which case a service executed by the application processor 125 may request allocation of resources on the baseband processor 130 to establish the call. For example the service executed by the application processor 125 can interface with a service executed by the baseband processor 130. On the other hand, if the call is requested via the external device 150, a service executed by the baseband processor 130 may itself establish the call, or interface with another service executed by the baseband processor 130 to establish the call.

Regardless of which processor 125, 130 executes the service requesting the call, or which service/processor ends the call, each of the processors 125, 130 can be informed of the call status. FIG. 2, for example, depicts a signal flow diagram 200 that indicates signals which may be generated in response to the call being requested via the external device 150. At step 202, the external device 150 can send a request to the baseband processor 130 to initiate a call service. In response to the call service being initiated, at step 204 the baseband processor can send a service initiated message to the external device 150, and at step 206 the baseband processor can send a service initiated message to the application processor 125 via the inter-process communications link.

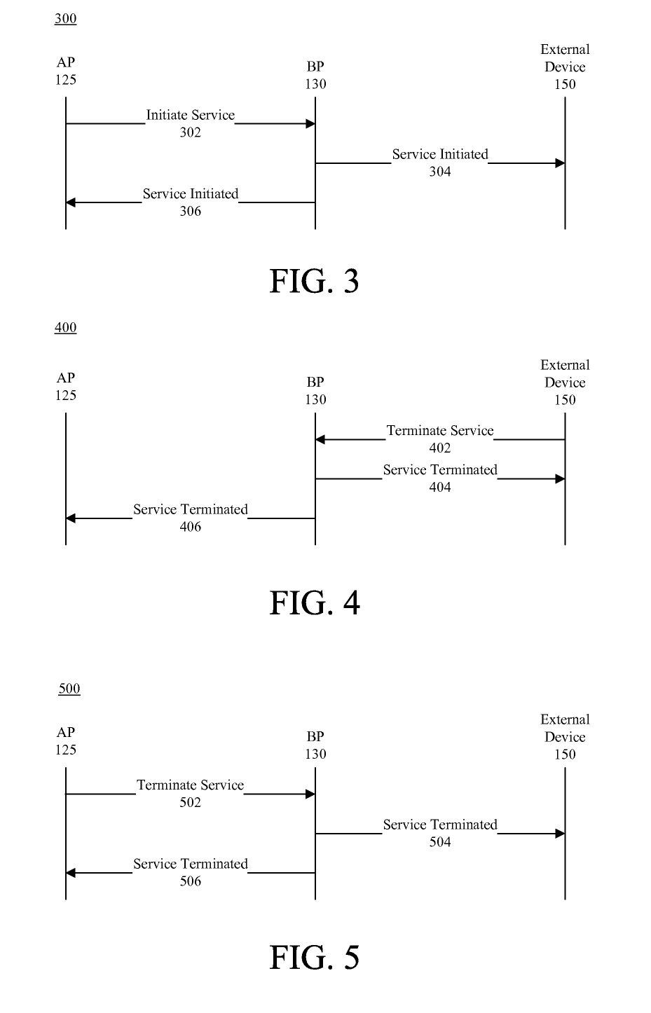

FIG. 3 depicts a signal flow diagram 300 that indicates signals which may be generated in response to the call being requested via the application processor 125. The call can be requested, for instance, in response to a user input received by the user interface. At step 302, the application processor 125 can send a request to the baseband processor 130 to initiate a call service. In response to the call service being initiated, at step 304 the baseband processor 130 can send a service initiated message to the external device 150, and at step 306 the baseband processor 130 can send a service initiated message to the application processor 125.

FIG. 4 depicts a signal flow diagram 400 that indicates signals which may be generated in response to the call termination being requested via the external device 150. At step 402, the external device 150 can send a request to the baseband processor 130 to terminate the call service. In response to the call service being terminated, at step 404 the baseband processor 130 can send a service terminated message to the external device 150, and at step 406 the baseband processor 130 can send a service terminated message to the application processor 125.

FIG. 5 depicts a signal flow diagram 500 that indicates signals which may be generated in response to the call termination being requested via the application processor 125. At step 502, the application processor 125 can send a request to the baseband processor 130 to terminate the call service. In response to the call service being terminated, at step 504 the baseband processor 130 can send a service terminated message to the external device 150, and at step 506 the baseband processor 130 can send a service terminated message to the application processor 125.

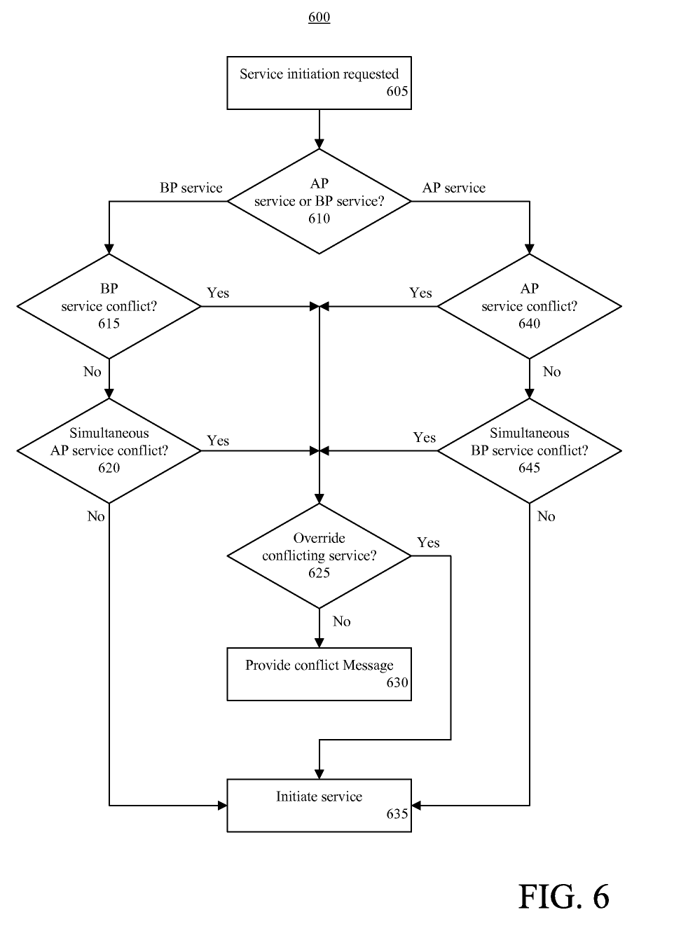

Although requests to initiate or terminate a call service can be generated by the application processor 125 or the external device 150, some requests may conflict with other services being executed on the communications device. FIG. 6 is a flowchart that is useful for understanding a method 600 for processing a service initiation request. The service initiation request can be a request for a call service, or any other service provided by the communication device. The method 600 can be implemented by the application processor, the baseband processor, or another suitable processor within the communication device, or otherwise communicatively linked to the communication device.

At step 605 a request for a service initiation can be received, for example via the external device or via the application processor on the communication device (e.g. responsive to user inputs entered via the user interface). Referring to decision box 610, if the service being requested is a service typically instantiated on the baseband processor, the process can proceed to decision box 615 where a determination can be made whether the requested service conflicts with another service instantiated on the baseband processor. If there is such a conflict, the process can proceed to decision box 625 and a determination can be made whether to override the conflicting service.

The decision whether to override the conflicting service can be based on any of a myriad of factors, some examples of which are discussed herein. For example, a priority level can be established for each of the services. If it is determined that the requested service has a higher priority level than the service instantiated on the baseband processor, at step 635 the requested service can be initiated. In addition, the service initiated messages previously discussed in the message flow diagrams can be provided by the baseband processor. Otherwise, at step 630, a conflict message can be provided. The conflict message can be provided via the user interface on the communication device or via the external device.

Referring again to decision box 615, if the requested service does not conflict with another service instantiated on the baseband processor, the process can proceed to decision box 620 and a decision can be made whether the requested service conflicts with another service that would be simultaneously instantiated on the application processor. If there is such a conflict, the process can again proceed to decision box 625, and a decision can be made whether to override the conflicting service on the application processor, for instance based on priorities assigned to the respective services. Based on the decision, a conflict message can be provided at step 630 or the service can be instantiated at 635. If there is no such conflict, the process can bypass decision box 625 and proceed to step 635 where the service can be instantiated.

In the example shown, the process can perform step 615 to determine whether there is a conflicting service on the baseband processor prior to determining whether there is a conflicting service on the application processor at step 620. It should be noted, however, that the respective positions of decision boxes 615 and 620 can be reversed in the flowchart, and the determination of whether there is a conflicting service on the application processor at step 620 can be performed prior to the determination of whether there is a conflicting service on the baseband processor.

Referring back to decision box 610, if the service being requested is a service typically instantiated on the application processor, the process can proceed to decision box 640 where a determination can be made whether the requested service conflicts with another service instantiated on the application processor. If there is such a conflict, the process can proceed to decision box 625 and an override decision can be made as previously described. If, however, there is no conflicting service instantiated on the application processor, the process can proceed to step 645 and a decision can be made whether the requested service conflicts with another service that would be simultaneously instantiated on the baseband processor. If there is such a conflict, the process can again proceed to decision box 625. If there is no such conflict, the process can proceed to step 635 and the requested service can be initiated.

In the example shown, the process can perform step 640 to determine whether there is a conflicting service on the application processor prior to determining whether there is a conflicting service on the baseband processor at step 645. Of course, the respective positions of decision boxes 640 and 645 can be reversed in the flowchart, and the determination of whether there is a conflicting service on the baseband processor at step 645 can be performed prior to the determination of whether there is a conflicting service on the application processor.

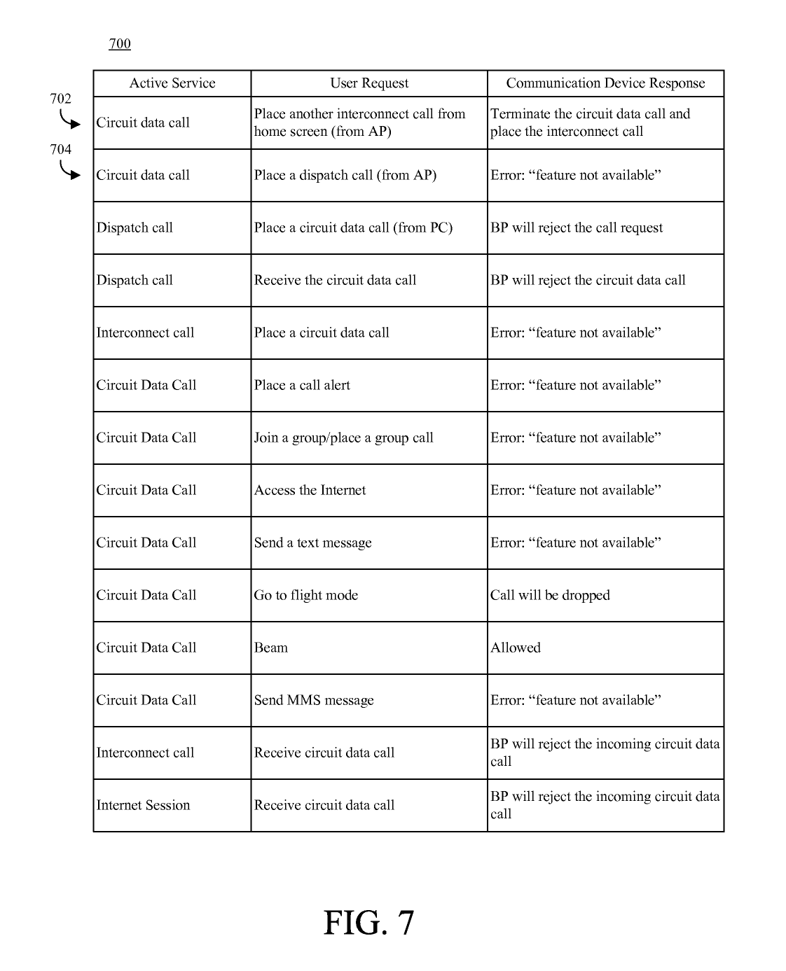

FIG. 7 presents a table 700, which is a priority table useful for understanding the present invention. In the table 700, three columns are presented. The first column, “Active Service,” indicates a service that may be presently active on a communication device. The second column, “User Request,” indicates a request that may be received by the communication device. Finally, the third column, “Communication Device Response,” indicates a response that may be generated by the communication device if the user request indicated in the second column is received while the service indicated in the first column is active. For example, referring to the first row 702 of the table 700, if a user request to “place another interconnect call from home screen” is received while a circuit data call is active, the communication device can respond by terminating the circuit data call and placing the interconnect call. Referring to the second row 704, if a user request to “place a dispatch call” is received while the circuit data call is active, the communication device can respond by providing a conflict message, or error message, such as “feature not available.” Still, a myriad of other priorities can be defined, some of which are presented in the table 700, and the invention is not limited in this regard.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for prioritizing communication services across multiple service initiators in a multi-modal communication device, comprising:
establishing an inter-process communications link between a first processor and at least a second processor within the communication device;
responsive to a request for a first service provided by the first processor, determining whether the first service has a higher priority than a second service currently active on a second processor; and
providing a conflict message in response to the second service having a higher priority than the first service, or initiating at least one process in response to the first service having a higher priority than the second service.

2. The method of claim 1, wherein initiating at least one process comprises:
initiating the first service; and
allocating resources of the second processor to the first service.

3. The method of claim 2, further comprising:
responsive to the first service being initiated, communicating a service initiated message from the second processor to an external device.

4. The method of claim 2, further comprising:
responsive to the first service being initiated, communicating a service initiated message from the second processor to the first processor.

5. The method of claim 2, further comprising:
terminating the first service; and
responsive to the first service being terminated, communicating a service terminated message from the second processor to an external device.

6. The method of claim 2, further comprising:
terminating the first service; and
responsive to the first service being terminated, communicating a service terminated message from the second processor to the first processor.

7. The method of claim 1, further comprising:
determining whether the first service has a higher priority than a third service currently active on a first processor; and
providing a conflict message in response to the third service having a higher priority than the first service.

8. A multi-modal communication device, comprising:
a first processor;
a second processor communicatively linked to the first processor via an inter-process communications link;
wherein, responsive to a request for a first service provided by the first processor, the communication device determines whether the first service has a higher priority than a second service currently active on a second processor; and
the communication device presents a conflict message in response to the second service having a higher priority than the first service, or initiates at least one process in response to the first service having a higher priority than the second service.

9. The communication device of claim 8, wherein the process that is initiated comprises initiation of the first service and allocation of second processor resources to the first service.

10. The communication device of claim 9, wherein the communication device communicates a service initiated message from the second processor to an external device in response to the first service being initiated.

11. The communication device of claim 9, wherein the communication device communicates a service initiated message from the second processor to the first processor in response to the first service being initiated.

12. The communication device of claim 9, wherein the communication device further terminates the first service and, responsive to the first service being terminated, communicates a service terminated message from the second processor to an external device.

13. The communication device of claim 9, wherein the communication device further terminates the first service and, responsive to the first service being terminated, communicates a service terminated message from the second processor to the first processor.

14. The communication device of claim 9, wherein the communication device determines whether the first service has a higher priority than a third service currently active on a first processor and, responsive to the third service having a higher priority than the first service, provides a conflict message.

15. A machine readable storage, having stored thereon a computer program having a plurality of code sections comprising:
code for establishing an inter-process communications link between a first processor and at least a second processor within the communication device;
code for determining whether the first service has a higher priority than a second service currently active on a second processor in response to a request for a first service provided by the first processor; and
code for providing a conflict message in response to the second service having a higher priority than the first service, or initiating at least one process in response to the first service having a higher priority than the second service.

16. The machine readable storage of claim 15, wherein the code for initiating at least one process comprises code for initiating the first service.

17. The machine readable storage of claim 16, further comprising code for communicating a service initiated message from the second processor to an external device in response to the first service being initiated.

18. The machine readable storage of claim 16, further comprising code for communicating a service initiated message from the second processor to the first processor in response to the first service being initiated.

19. The machine readable storage of claim 16, further comprising:
code for terminating the first service; and
code for communicating a service terminated message from the second processor to an external device in response to the first service being terminated.

20. The machine readable storage of claim 16, further comprising:
code for terminating the first service; and
code for communicating a service terminated message from the second processor to the first processor in response to the first service being terminated.
